(19) United States
(12) Patent Application Publication
(10) Pub. No.: US 2018/0261131 A1
(43) Pub. Date: Sep. 13, 2018

(54) Robotic Instructor And Demonstrator To Train Humans As Automation Specialists

(71) Applicant: Boston Incubator Center, LLC, Waltham, MA (US)

(72) Inventor: Haruhiko Harry Asada, Lincoln, MA (US)

(21) Appl. No.: 15/915,021

(22) Filed: Mar. 7, 2018

Related U.S. Application Data
(60) Provisional application No. 62/468,110, filed on Mar. 7, 2017.

(51) Int. Cl. G09B 25/02; G09B 5/06; B25J 11/00; B25J 9/00

(52) U.S. Cl. CPC G09B 25/02; B25J 9/0087; B25J 11/008; G09B 5/06

(57) ABSTRACT

Methods and systems for training a broad population of learners in the field of robotics and automation technology based on physical interactions with a robotic training system are described herein. Specifically, a robotic instructor provides audio-visual instruction and physically interacts with human learners to effectively teach robotics and automation concepts and evaluate learner understanding of those concepts. In some examples, a training robot instructs and demonstrates encoder operation, feedback control, and robot motion coordination with external objects and events while physically interacting with a human learner. In some examples, interlock logic and waypoints of the training robot are programmed by the human user while the training robot physically interacts with the human learner. In a further aspect, a training robot evaluates the proficiency of a human learner with respect to particular robotic concepts. Future instruction by the training robot is determined in part by the measured proficiency.

### CROSS REFERENCE TO RELATED APPLICATIONS

The present application for patent claims priority under 35 U.S.C. § 119 from U.S. provisional patent application Ser. No. 62/468,110, entitled “Method and Apparatus of a Hands-on Robot Instructor and Demonstrator that Can Teach Humans,” filed Mar. 7, 2017, the subject matter of which is incorporated herein by reference in its entirety.

### TECHNICAL FIELD

The described embodiments relate to systems and methods for payload transport in a service environment.

### BACKGROUND INFORMATION

The shortage of qualified manufacturing and automation engineers is one of the primary factors hampering technological advancement of the domestic manufacturing industry. Robotics is a major driver of manufacturing innovation, and the shortage of trained personnel who can effectively deploy robots in a manufacturing environment limits the realization of the benefits of manufacturing innovation.

While the number of people entering apprenticeship programs focused on the construction industries is large, those entering apprenticeship programs focused on manufacturing automation and robotics is negligible. In fact, in many states there are no robotics and automation focused apprenticeship programs available. Thus, while the need for advanced manufacturing and robotics is increasing to maintain global competitiveness, a significant talent shortage and skills gap hampers the growth of manufacturing industries.

There are several factors that impede workforce development in robotics and automation. In the United States it is very common for manufacturers to outsource the assembly, programming, testing, and maintenance of robotic equipment and peripheral automation systems to system integrators. As a result, many manufacturers lack in-house skills and expertise to continually maintain and improve system performance. In particular, many manufacturers are unable to redirect existing automation systems to accomplish different tasks because of the lack of in-house expertise. As a result, the cost benefits of flexible automation and robotics are unrealized because manufacturers are unable to efficiently deploy existing capital equipment to new tasks. This limits deployment of automation and robotics to very large production runs instead of leveraging the benefits of automation and robotics to smaller production activities. In practice, this limits the deployment of automation and robotic technologies to a few large manufacturing firms and largely excludes small to medium sized manufacturers that comprise a significant portion of the domestic manufacturing base.

Another significant factor that impedes workforce development in robotics and automation is a shortage of experienced mentors. A skilled worker/engineer base has not developed in manufacturing robotics. Without adequate numbers of experienced mentors it is not possible to develop successful apprenticeship training programs on a large scale. Thus, the shortage of qualified instructors who can successfully teach manufacturing robotics is a major impediment to the development widely available apprenticeship programs.

Federal and local government entities as well as industrial groups and manufacturing businesses recognize workforce development as a top priority. They wish to dramatically expand the population of manufacturing engineers by reaching out to a broad workforce including those with no formal engineering training. To achieve this goal workforce training systems must be developed that can engage, enlighten, and ultimately train a broad cross-section of people to be operators and users of advanced automation systems and technology.

Existing online learning systems provide students with recorded lectures, videos, and other teaching materials. These systems also store and analyze student responses to questions, assignments, and quizzes. However, online learning systems do not have the capability to perform physical demonstrations and physically interact with the student. On the other hand, demonstration rigs, equipment, and devices do not deliver a contemporaneous lecture, are unable to provide assignments, quizzes, and questions, cannot analyze responses from each student, and redirect the physical demonstrations and physical interaction based on the student responses. Thus, existing online learning systems and demonstration equipment struggle to provide effective workforce training for aspiring robotics and automation specialists.

In summary, improvements to workforce training systems for robotics and automation specialists are desired to bootstrap the development of a broad base of workers who can effectively deploy robotic and automation technology to diverse manufacturing tasks.

### SUMMARY

Methods and systems for training a broad population of learners in the field of robotics and automation technology based on physical interactions with a robotic training system are described herein. Specifically, a robotic instructor provides audio-visual instruction, and physically interacts with human learners to effectively teach robotics and automation concepts and evaluate learner understanding of those concepts.

In one aspect, one or more actuators of a training robot are backdriveable. Backdriveable motors enable earners to move one or more joints by pushing and pulling the robot structure and feel the restoring force generated by the backdriveable actuators. In this sense, the learner is able to physically feel the forces and torques imposed by the training robot for different control scenarios.

In another aspect, a training robot includes transparent covers or shields over one or more actuators and joint sensors to visually expose the one or more actuators and joint sensors to a human learner. This enables a human learner to visually identify important elements of a training robot while during operation of the training robot.

In another aspect, a training robot demonstrates how a robot precisely moves its joints to desired angles. An audio/visual explanation of the principle of an optical shaft encoder is presented to a human learner. In one example, a training robot moves a joint and displays a plot of encoder counts. In another example, a training robot audibly requests that a human learner grasp an end effector of the training robot and move a joint of the training robot under the user's own power. While this movement occurs, the training robot displays a plot of encoder counts.

In another aspect, a training robot demonstrates the concept of feedback control. An audio/visual explanation of the principle of feedback control is presented to the human learner. The training robot audibly requests that the human learner grasp an end effector of the training robot and move a joint of the training robot. While this movement occurs, the training robot implements feedback control at the moving joint and generates a restoring force opposite the force exerted by the human learner. While this interaction occurs, the training robot displays a plot of torque generated by the joint actuator, a plot of the commanded position and current deviation from the commanded position, etc.

In another aspect, a training robot instructs a human learner to coordinate robot motion with external objects and events. In some examples, the concepts of interlock logic and waypoints are taught to the human learner by the training robot. In some of these examples, the training robot teaches the concepts of interlock logic and waypoints by demonstrating a failure as a result of improper application of interlock logic and waypoints. These failures motivate the human learner to recognize the importance of the concepts and how to apply to concepts to avoid failure in the future.

In a further aspect, a training robot monitors and evaluates responses of the human learner to queries communicated to the human learner from the training robot. Based on the responses of the human learner to these queries, the training robot evaluates the proficiency of the human learner with respect to particular robotic concepts. Future instruction by the training robot is determined in part by the measured proficiency of the human learner. In this manner, the instructional materials and exercises are customized and tuned to the specific needs of individual learners.

The foregoing is a summary and thus contains, by necessity, simplifications, generalizations, and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of a robotic training system 100 in at least one novel aspect.

FIG. 2 is a diagram illustrative of elements of a robotic training system 100.

FIGS. 3A-3B depict illustrations of a human learner physically interacting with a training robot under feedback control.

FIG. 4 depicts an illustration of a training robot palletizing a work-piece from a machining center in one embodiment.

FIG. 5 illustrates a flowchart of a method 300 implementing robotic instruction, physical demonstration, and physical interaction functionality as described herein.

### DETAILED DESCRIPTION

Reference will now be made in detail to background examples and some embodiments of the invention, examples of which are illustrated in the accompanying drawings.

Many of the concepts and practical implementation details associated with robotics and automation technology are challenging for human learners to master. Meaningful learning experiences incorporating traditional “chalk-talk” instruction and actual physical interactions with robotic equipment are more effective than verbal instruction alone.

Methods and systems for training a broad population of learners in the field of robotics and automation technology based on physical interactions with a robotic training system are described herein. Specifically, a robotic instructor provides audio-visual instruction, and physically interacts with human learners to effectively teach robotics and automation concepts and evaluate learner understanding of those concepts.

Communications through an audio-visual display alone are unable to convey many of the key pedagogical elements of robotics. The sense of dynamic movements and spatiotemporal coordination as well as a physical understanding of robot function are pivotal to robotics education and training. These concepts are difficult to teach without physical demonstration and interactions, particularly to non-engineering personnel. By incorporating physical interactions with robotics and automation equipment along with instruction, demonstrations, and evaluations performed by the same robotics and automation equipment, meaningful learning experiences are stimulated in a broad population of people with varied educational backgrounds; beyond traditional college prepared students. In this manner, a robotic instructor based workforce training system delivers high-quality, low-cost, personalized training curricula to individuals, enterprises, and vocational schools, while lowering barriers for first-time users of manufacturing robotics.

Manipulation of a robot or automation equipment motivates, focuses, and engages a human learner to better assimilate a subject or activity. Learners question or seek explanations concerning the effects of the use of a robot in particular contexts to bring about desired results. In general, a learner contemplates two questions while physically interacting with a robot: “What does this robot do?” and “What can I do with this robot?”

One of the central objectives of learning robotics is to design, plan, and program a given task using robots. It is important to not only learn what a robot can do, but to also conceive what can be done with the robot. To be an effective robot and automation specialist, a human learner must be able to interpret an automation goal, the requirements and conditions of a given task, understand the functions and limitations of robots and peripheral automation devices, and ultimately find a way to achieve the task goal by generating a sequence of commands for the robot and any other automation equipment.

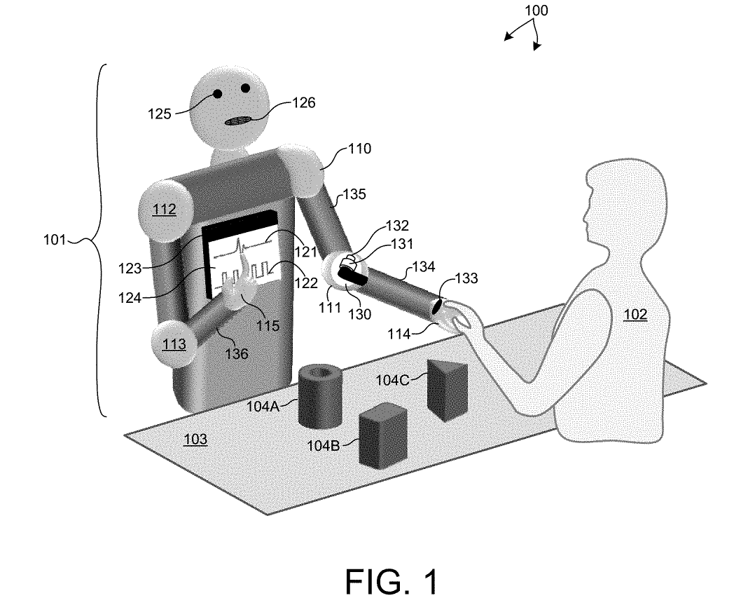

FIG. 1 depicts a robotic training system 100 in one embodiment. In the embodiment depicted in FIG. 1, robotic training system 100 includes a training robot 101, an audio output device 126, a video output device 124, an audio capture device 123, a video capture device 125, and a task environment 103 within the workspace of training robot 101. The task environment 103 includes objects 104A-C, which are manipulated by the training robot 101 and the human learner 102 for instructional purposes. As depicted in FIG. 1, training robot 101 includes one or more joints (e.g., joints 110-113). Each joint is moveable in one or more degrees of freedom by one or more actuators. The movement of each joint is measured by one or more joint sensors. For example, joint 111 is a revolute joint that couples arm structure 134 to arm structure 135. Actuator 131 rotates arm structure 134 with respect to arm structure 135, and joint sensor 132 measures the rotational displacement of arm structure 134 with respect to arm structure 135. In addition, training robot 101 includes one or more end effectors (e.g., end effector 114 attached to arm structure 134 and end effector 115 attached to arm structure 136). End effectors 114 and 115 are designed to grasp objects and point out specific objects to human learner 102 for purposes during physical instruction. Training robot 101 also includes a user input device 133. In the embodiment depicted in FIG. 1, user input device 133 is a button switch. Human learner 102 presses the button switch to signal specific positions of training robot 101 while human learner 102 is learning to program training robot 101.

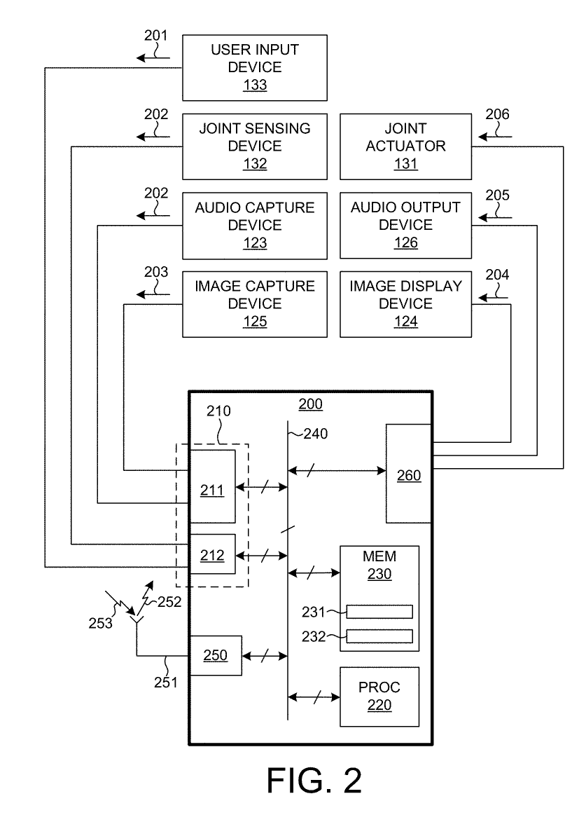

FIG. 2 is a diagram illustrative of elements of a training robot 101 including computing system 200, user input device 133, joint sensing device 132, audio capture device 123, image capture device 125, joint actuator 131, audio output device 126, and image display device 124. In the embodiment depicted in FIG. 2, computing system 200 is communicatively coupled to user input device 133, joint sensing device 132, audio capture device 123, image capture device 125, joint actuator 131, audio output device 126, and image display device 124 by wired communications links. However, in general, computing system 200 may be communicatively coupled to any of the sensors and devices described herein by either a wired or wireless communication link.

In general, any number of sensors and devices attached to training robot 101 to interact audibly, visually, and physically with a human learner may be communicatively coupled to computing system 200.

As depicted in FIG. 2, computing system 200 includes a sensor interface 210, at least one processor 220, a memory 230, a bus 240, a wireless communication transceiver 250, and a controlled device interface 260. Sensor interface 210, processor 220, memory 230, wireless communication transceiver 250, and controlled device interface 260 are configured to communicate over bus 240.

Sensor interface 210 includes analog to digital conversion (ADC) electronics 211. In addition, in some embodiments, sensor interface 210 includes a digital input/output interface 212. In some other embodiments, sensor interface 210 includes a wireless communications transceiver (not shown) configured to communicate with a sensor to receive measurement data from the sensor.

As depicted in FIG. 2, ADC 211 is configured to receive signals 202 from audio capture device 123. In another non-limiting example, ADC 211 is configured to receive signals 203 from image capture device 125. ADC 211 is further configured to convert the analog signals 202 and 203 into equivalent digital signals suitable for digital storage and further digital processing. ADC 211 is selected to ensure that the resulting digital signal is a suitably accurate representation of the incoming analog signals (i.e., quantization and temporal discretization errors are within acceptable error levels). In some other embodiments, image capture device 125 and audio capture device 123 include image and audio capture and processing capability on-board. In these embodiments, image and audio data are communicated digitally to computing system 200.

As depicted in FIG. 2, digital I/O 212 is configured to receive digital signals 202 from joint sensing device 132 and digital signals 201 from user input device 133. In this example, joint sensing device 132 includes on-board electronics to generate digital signals 202 indicative of a measured displacement of a joint of training robot 101. In this manner, computing system 200 is configured to interface with both analog and digital sensors. In general, any of the sensors described herein may be digital or analog sensors, and may be communicatively coupled to computing system 200 by the appropriate interface.

Controlled device interface 160 includes appropriate digital to analog conversion (DAC) electronics. In addition, in some embodiments, controlled device interface 160 includes a digital input/output interface. In some other embodiments, controlled device interface 160 includes a wireless communications transceiver configured to communicate with a device, including the transmission of control signals.

As depicted in FIG. 2, controlled device interface 160 is configured to transmit control commands 206 to one or more joint actuators 131 that cause the training robot 101 to move, for example, along a desired motion trajectory. In another non-limiting example, controlled device interface 160 is configured to transmit command signals 205 to audio output device 126, such as a speaker, that causes the speaker to audibly communicate with human learner 102. In yet another non-limiting example, controlled device interface 160 is configured to transmit display signals 204 to image display device 124 that cause the image display device 124 to visually communicate with human learner 102. In general, any combination of audio/visual input and output devices may be contemplated to implement a natural language communication interface between training robot 101 and a human learner 102 to facilitate robotics and automation instruction as described herein.

Memory 230 includes an amount of memory 231 that stores instructional materials employed by training robot 101 to instruct human learner 102. Memory 230 also includes an amount of memory 232 that stores program code that, when executed by processor 220, causes processor 220 to implement instructional functionality, physical demonstration functionality, physical interaction functionality, and evaluation functionality as described herein.

In some examples, processor 220 is configured to store digital signals generated by sensor interface 210 onto memory 230. In addition, processor 220 is configured to read the digital signals stored on memory 230 and transmit the digital signals to wireless communication transceiver 250. In some embodiments, wireless communications transceiver 250 is configured to communicate the digital signals from computing system 200 to an external computing device (not shown) over a wireless communications link. As depicted in FIG. 2, wireless communications transceiver transmits a radio frequency signal 252 over antenna 251. The radio frequency signal 252 includes digital information indicative of the digital signals to be communicated from computing system 200 to the external computing device. In one example, evaluation data generated by computer system 200 are communicated to an external computing system (not shown) for purposes of monitoring and redirecting the instruction provided by training robot 101 to human learner 102 based on the evaluation data.

In some embodiments, wireless communications transceiver 250 is configured to receive digital signals from an external computing device (not shown) over a wireless communications link. The radio frequency signals 253 includes digital information indicative of the digital signals to be communicated from an external computing system (not shown) and computing system 200. In one example, instructional materials generated by an external computing system are communicated to computer system 200 for implementation by training robot 101. In some embodiments, the instructional materials are provided to training robot 101 based on an evaluation of the level of mastery of human learner 102 over one or more robotic concepts performed by training robot 101.

In one aspect, one or more actuators of training robot 101 is backdriveable. For example, actuator 131 is a backdriveable electrically driven motor and joint sensor 132 is a rotary encoder. A backdriveable motor has low mechanical output impedance (e.g., direct drive motors, motors incorporating low-gear reduction and low friction, etc.) Backdriveable motors enable torque control of a robot joint. More importantly, backdriveable motors enable learners to move one or more joints by pushing and pulling the robot structure and feel the restoring force generated by the backdriveable actuators. In this sense, the learner is able to physically feel the forces and torques imposed by the training robot for different control scenarios.

In another aspect, training robot 101 includes transparent covers or shields over one or more actuators and joint sensors to visually expose the one or more actuators and joint sensors to human learner 102. For example, training robot 101 includes transparent cover 130 that visually exposes actuator 131 and rotary encoder 132 to human learner 102. In this manner, important elements of training robot 101 that are normally covered and out of sight of humans are visually exposed to the human learner. This enables the human learner 102 to visually identify important elements of training robot 101 while they operating as part of training robot 101.

In one example, training robot 101 points to rotary encoder 132 with end effector 115 or displays a picture of rotary encoder 132 on display 124, while audibly describing the function of rotary encoder 132. In this example, training robot 101 teaches human learner 102 how arm structure 134 is moved with respect to arm structure 135 by exposing actuator 131 and rotary encoder 132. Human learner 102 can see motor 131 spinning and encoder 132 counting ticks through transparent cover 130, while training robot 101 moves arm structure 134 with respect to arm structure 135.

In another aspect, training robot 101 demonstrates how a robot precisely moves its joints to desired angles. A shaft encoder plays a key role in close-loop control by measuring its joint angle. Computing system 200 transmits audio signals to audio output device 126 and image signals 204 to image display device 124 that the cause the audio output device 126 and image display device 124 to present an audio/visual explanation of the principle of an optical shaft encoder in accordance with instructional materials stored in memory 231. In addition, training robot 101 communicates control commands 206 to actuator 131 that causes actuator 131 to rotate joint 111. While this movement occurs, video output device 124 displays a plot 122 of encoder counts. In another example, computing system 200 transmits audio signals to audio output device 126 that the cause the audio output device 126 to audibly request that human learner 102 touch training robot 101 at end effector 114 and move joint 111 under their own power. While this movement occurs, video output device 124 displays a plot 122 of encoder counts.

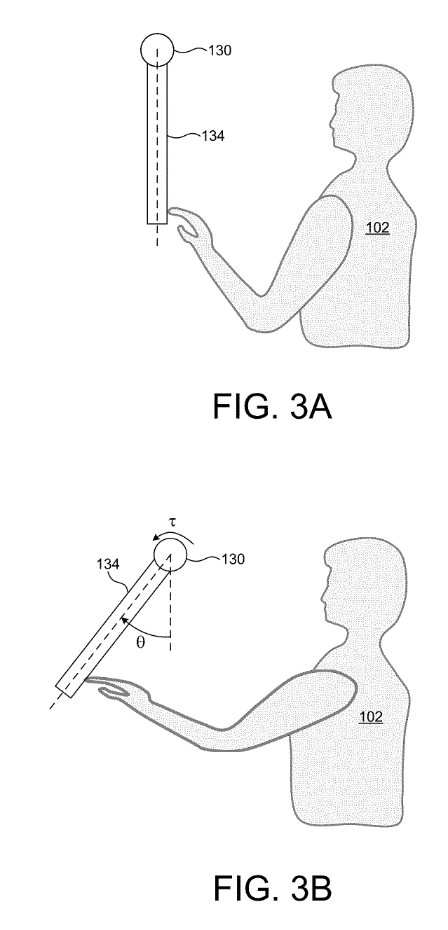

In another aspect, training robot 101 demonstrates the concept of feedback control as a method that a robot uses to control position, velocity, force, torque, etc. In one example, computing system 200 transmits audio signals to audio output device 126 and image signals 204 to image display device 124 that the cause the audio output device 126 and image display device 124 to present an audio/visual explanation of the principle of feedback control in accordance with instructional materials stored in memory 231. In addition, computing system 200 transmits audio signals to audio output device 126 that the cause the audio output device 126 to audibly request that human learner 102 touch training robot 101 at end effector 114 and move joint 111 under their own power. For example, as depicted in FIG. 3A, human learner 102 touches arm structure 134 at a commanded position of actuator 130 (i.e., θ=0). At this position, human learner 102 feels no interaction force. As depicted in FIG. 3B, human learner 102 presses against arm structure 134 and displaces arm structure 134 at an angle, θ, with respect to the commanded position. While this movement occurs, training robot 101 implements feedback control at joint 111 and generates a restoring force opposite the force exerted by human learner 102 on training robot 101. While this interaction occurs, video output device 124 displays a plot 121 of torque, τ, generated by actuator 131. In another example, video output device 124 displays a plot of the commanded position and current deviation from the commanded position (i.e., feedback error signal) along with the restoring torque. Training robot 101 engages in this physical interaction with human learner 102 at different feedback control parameter values (e.g., position feedback, velocity feedback, integrated position feedback, etc.). In this manner, human learner 102 physically ‘feels’ the effects of feedback control and how the effect changes depending on feedback control parameter values.

In another aspect, training robot 101 instructs human learner 102 regarding concepts related to coordinating robot motion with external objects and events. In some examples, the concepts of interlock logic and waypoints are taught to human learner 102 by training robot 101. In some of these examples, training robot 101 teaches the concepts of interlock logic and waypoints by demonstrating a failure as a result of improper application of interlock logic and waypoints. These failures motivate human learner 102 to recognize the importance of the concepts and how to apply to concepts to avoid failure in the future.

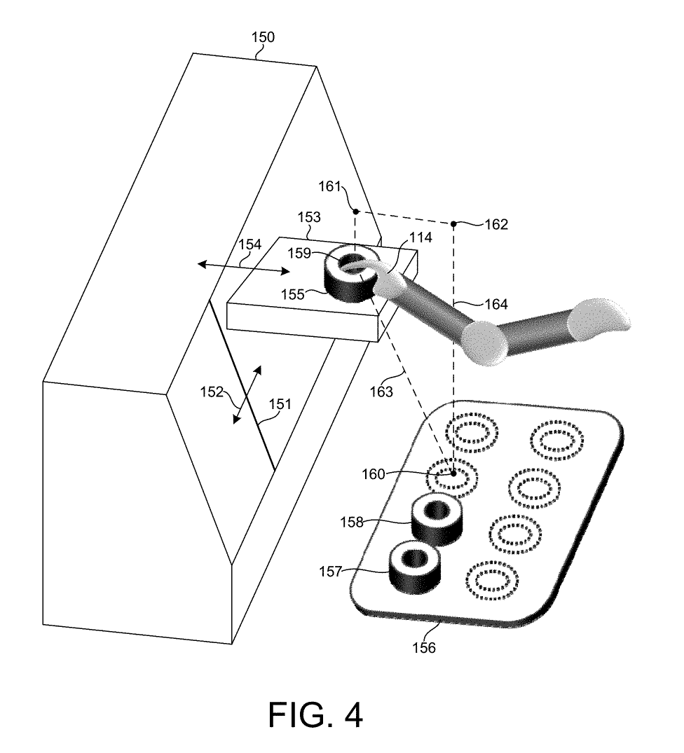

FIG. 4 depicts a machining center 150 including a door 151 and a transfer structure 153. Actuator 152 opens and closes door 151 and actuator 154 moves transfer structure 153 to a load/unload position. As depicted in FIG. 4, work-pieces 157 and 158 are stored on a pallet 156. Work-piece 155 is located on transfer structure 153. The objective is to move work-piece 155 from location 159 on transfer structure 153 to location 160 on pallet 156.

Interlock logic is an important technique in automation to coordinate the motion of a robot with other machines and peripheral devices in a task environment. In the example depicted in FIG. 4, the robot must be programmed to remove a work-piece only after confirming that the cutting process is completed, door 151 is open, and transfer structure 153 is in the load/unload position.

In one example, computing system 200 transmits audio signals to audio output device 126 and image signals 204 to image display device 124 that the cause the audio output device 126 and image display device 124 to present an audio/visual explanation of the principle of interlock logic in accordance with instructional materials stored in memory 231. In addition, training robot 101 communicates control commands 206 to actuator 131 that causes actuator 131 to move end effector 114 toward position 159 before door 151 is open. This results in a collision between machining center 150 and training robot 101.

Computing system 200 transmits audio signals to audio output device 126 that the cause the audio output device 126 to request that the human learner 102 program an interlock to ensure that training robot 101 waits until door 151 is open and transfer structure 153 is in the unload/load position before training robot 101 begins to move toward machining center 150.

In addition, computing system 200 transmits audio signals to audio output device 126 that the cause the audio output device 126 to request that the human learner 102 physically grasp end effector 114 and move training robot 101 from position 159 to position 160. At the two endpoint positions, the human learner 102 presses button 133 to indicate that these are the desired endpoints of the programmed motion. After programming the endpoints, computing system 200 communicates control commands 206 to actuator 131 that causes actuator 131 to move end effector 114 directly from position 159 to position 160 along trajectory 163. However, this results in a collision between transfer structure 153 and training robot 101.

Computing system 200 transmits audio signals to audio output device 126 that the cause the audio output device 126 to request that the human learner 102 program an one or more waypoints to ensure that training robot 101 traverses a path between endpoint positions 159 and 160 that is clear of interference between training robot 101 and machining center 150. The human learner 102 physically grasps end effector 114 and moves training robot 101 from position 159 to waypoint position 161, then to way point position 162, and then to endpoint 160. At the two endpoint and waypoint positions, the human learner 102 presses button 133 to indicate that these are the desired endpoints and waypoints of the programmed motion. After programming the endpoints and waypoints, computing system 200 communicates control commands 206 to actuator 131 that causes actuator 131 to move end effector 114 from position 159 to position 160 via waypoints 161 and 162 along trajectory 164. This results in a successful transfer of work-piece 155 from transfer structure 153 and pallet 156.

The training robot interacts physically, visually, and audibly with the human learner. In a further aspect, training robot 101 monitors and evaluates responses of the human learner to queries communicated to the human learner from the training robot. Based on the responses of the human learner to these queries, the training robot evaluates the proficiency of the human learner with respect to particular robotic concepts. Future instruction by the training robot is determined in part by the measured proficiency of the human learner. In this manner, the instructional materials and exercises are customized and tuned to the specific needs of individual learners.

In some embodiments, computing system 200 is communicatively coupled to an external computing system residing in a cloud computing environment. The external computing system stores a series of training courses. The interaction with learners is greatly enhanced by the training robot.

In general, a training robot may be configured in any suitable manner. For example, a training robot may include one or more arms, legs, head, neck, elbows, shoulders, grippers, fingers, or any other suitable appendage. The training robot communicates audibly, visually, and physically with the human learner in any suitable manner. For example, the training robot may communicate audibly and visually with the human learner in any of a number of different natural languages. The training robot is configured to deliver lecture materials, instructions, videos, and multimedia content to learners via any suitable combination of audio, visual, and physical interfaces. The training robot is also capable of monitoring, sensing, detecting, and observing the human learner, other objects, devices, and machines using computer vision, force and moment sensors, tactile and haptic sensors, range sensors, proximity sensors, etc. In one example the training robot includes a natural language interface that enables the training robot to understand questions and comments made by a human learner and respond accordingly.

The task environment is the space where both the training robot and the human learner physically interact to change the state of the environment to learn robotics concepts and to program the training robot. In some examples, the task environment includes projectors, monitors, paintings, drawings, or signage, that exhibit other machines, peripheral devices, other people, buildings, infrastructure, etc., associated with one or more different manufacturing environments. In this manner, the human learner is exposed to a realistic manufacturing environment without actually being present in a real manufacturing environment.

In general, a training robot may communicate instructional materials and perform physical demonstrations to a human learner simultaneously or sequentially. Similarly, a training robot may physically interact with a human learner and provide additional information regarding the robotics concepts being explored in the physical interaction simultaneously or sequentially.

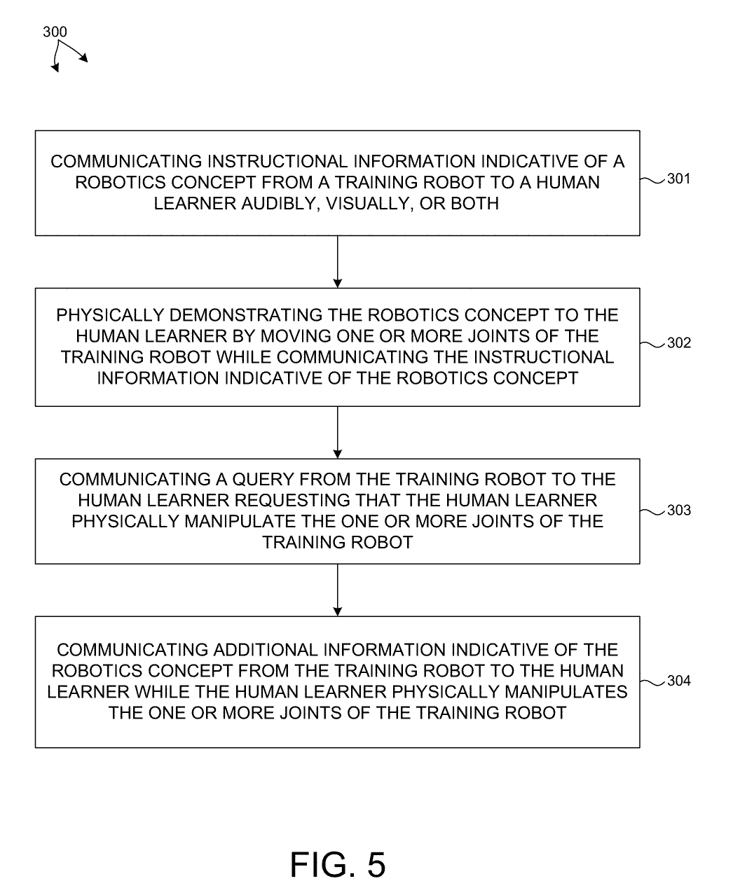

FIG. 12 illustrates a flowchart of a method 300 suitable for implementation by a robotic training system as described herein. In some embodiments, robotic training system 100 is operable in accordance with method 300 illustrated in FIG. 5. However, in general, the execution of method 300 is not limited to the embodiments of robotic training system 100 described with reference to FIGS. 1-4. These illustrations and corresponding explanation are provided by way of example as many other embodiments and operational examples may be contemplated within the scope of this patent document.

In block 301, a training robot communicates instructional information indicative of a robotics concept to a human learner audibly, visually, or both.

In block 302, the training robot physically demonstrates the robotics concept to the human learner by moving one or more joints of the training robot while communicating the instructional information indicative of the robotics concept.

In block 303, a query is communicated from the training robot to the human learner requesting that the human learner physically manipulate the one or more joints of the training robot.

In block 304, additional information indicative of the robotics concept is communicated from the training robot to the human learner by the training robot while the human learner physically manipulates the one or more joints of the training robot.

The computing system 200 may include, but is not limited to, a personal computer system, mainframe computer system, workstation, image computer, parallel processor, or any other computing device known in the art. In general, the term “computing system” may be broadly defined to encompass any device, or combination of devices, having one or more processors, which execute instructions from a memory medium. In general, computing system 200 may be integrated with a training robot, such as training robot 101, or alternatively, may be separate, entirely, or in part, from any training robot. In this sense, computing system 200 may be remotely located and receive data and transmit command signals to any element of training robot 101.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A robotic training system comprising:
a training robot including one or more joints, one or more actuators configured to move each of the one or more joints, and one or more joint sensors that sense a movement of each of the one or more joints;
an audio output device configured to communicate audio information to a human learner interacting with the training robot;
a video output device configured to communicate image information to a human learner interacting with the training robot:
a task environment within a workspace of the training robot including one or more objects; and
a computing system communicatively coupled to the training robot, the audio output device, and the video output device, the computing system configured to:
communicate audio signals, video signals, or both, to the audio output device, the video output device, or both, respectively, that cause the audio output device, the video output device, or both, to communicate instructional information indicative of a robotics concept to the human learner;
communicate control commands to the one or more actuators of the training robot that cause the training robot to physically demonstrate the robotics concept to the human learner by moving the one or more joints;
communicate audio signals, video signals, or both, to the audio output device, the video output device, or both, respectively, that cause the audio output device, the video output device, or both, to communicate a query to the human learner requesting that the human learner physically manipulate the one or more joints of the training robot;
communicate audio signals, video signals, or both, to the audio output device, the video output device, or both, respectively, that cause the audio output device, the video output device, or both, to respond to the human learner physically manipulating the one or more joints of the training robot by communicating additional information indicative of the robotics concept to the human learner.

2. The robotic training system of claim 1, wherein the communicating of the information indicative of a robotics concept to the human learner and the physical demonstration of the robotics concept to the human learner are performed simultaneously.

3. The robotic training system of claim 1, wherein the computing system is further configured to:
communicate video signals to the video output device that causes the video output device to display information related to the movement of the one or more joints simultaneous with the movement of the one or more joints.

4. The robotic training system of claim 1, wherein the computing system is further configured to:
communicate control commands to the one or more actuators of the training robot that cause the training robot to physically respond to the human learner physically manipulating the one or more joints of the training robot by exerting a restoring force opposite a force exerted by the human learner onto the training robot while communicating the additional information indicative of the robotics concept to the human learner.

5. The robotic training system of claim 1, wherein the human learner, in response to the request that the human learner physically manipulate the one or more joints of the training robot, causes the training robot to manipulate the one or more objects in the task environment.

6. The robotic training system of claim 1, wherein the manipulation of the one or more joints of the training robot by the human learner indicates one or more waypoints in the workspace of the training robot.

7. The robotic training system of claim 1, wherein the control commands communicated to the one or more actuators of the training robot that cause the training robot to physically demonstrate the robotics concept causes the training robot to collide with the one or more objects in the task environment.

8. The robotic training system of claim 7, wherein the display of information related to the movement of the one or more joints on the display of the audio/visual output device communicates a reason for the collision of the training robot with the one or more objects in the task environment and communicates a solution to avoid the collision in the future.

9. The robotic training system of claim 1, the training robot further comprising:
one or more transparent covers that visually expose the one or more actuators, the one or more joint sensors, or both, to the human learner.

10. The robotic training system of claim 1, wherein the one or more actuators of the training robot are backdrivable.

11. The robotic training system of claim 1, wherein the audio and video output devices communicate information to the human learner in one of a plurality of natural languages.

12. The robotic training system of claim 1, the task environment further comprising:
a second audio output device, a second video output device, or, both, configured to communicate images, sounds, or both, of a manufacturing environment including robotics and automation equipment to the human learner.

13. The robotic training system of claim 1, wherein the computing system is further configured to:
store responses from the human learner to one or more queries communicated to the human learner by the training robot;
evaluate a degree of proficiency of the robotics concept by the human learner; and
communicate instructional materials to the training robot based on the degree of proficiency of the human learner.

14. The robotic training system of claim 1, further comprising:
an audio capture device, a video capture device, or both, configured to receive natural language input from the human learner interacting with the training robot.

15. A method comprising:
communicating instructional information indicative of a robotics concept from a training robot to a human learner audibly, visually, or both;
physically demonstrating the robotics concept to the human learner by moving one or more joints of the training robot while communicating the instructional information indicative of the robotics concept;
communicating a query from the training robot to the human learner requesting that the human learner physically manipulate the one or more joints of the training robot; and
communicating additional information indicative of the robotics concept from the training robot to the human learner while the human learner physically manipulates the one or more joints of the training robot.

16. The method of claim 15, wherein the additional information includes information related to the movement of the one or more joints.

17. The method of claim 15, wherein the training robot exerts a restoring force opposite a force exerted by the human learner onto the training robot.

18. The method of claim 15, wherein physically demonstrating the robotics concept to the human learner involves a collision between the training robot and the one or more objects in the task environment.

19. The method of claim 15, further comprising:
storing responses from the human learner to one or more queries communicated to the human learner by the training robot;
evaluating a degree of proficiency of the robotics concept by the human learner; and
communicating instructional materials to the training robot based on the degree of proficiency of the human learner.

20. A robotic training system comprising:
a training robot including one or more joints, one or more actuators configured to move each of the one or more joints, and one or more joint sensors that sense a movement of each of the one or more joints;
an audio output device configured to communicate audio information to a human learner interacting with the training robot;
a video output device configured to communicate image information to a human learner interacting with the training robot:
a task environment within a workspace of the training robot including one or more objects; and
a non-transitory, computer-readable medium storing instructions that when executed by a computing system cause the computing system to:
communicate audio signals, video signals, or both, to the audio output device, the video output device, or both, respectively, that cause the audio output device, the video output device, or both, to communicate instructional information indicative of a robotics concept to the human learner;
communicate control commands to the one or more actuators of the training robot that cause the training robot to physically demonstrate the robotics concept to the human learner by moving the one or more joints;
communicate audio signals, video signals, or both, to the audio output device, the video output device, or both, respectively, that cause the audio output device, the video output device, or both, to communicate a query to the human learner requesting that the human learner physically manipulate the one or more joints of the training robot; and
communicate audio signals, video signals, or both, to the audio output device, the video output device, or both, respectively, that cause the audio output device, the video output device, or both, to respond to the human learner physically manipulating the one or more joints of the training robot by communicating additional information indicative of the robotics concept to the human learner.
